(19) United States
(12) Patent Application Publication
(10) Pub. No.: US 2026/0296556 A1
(43) Pub. Date: Oct. 1, 2026

(54) VEHICLE BODY SIDE STRUCTURE

(71) Applicant: Honda Motor Co., Ltd., Tokyo (JP)

(72) Inventors: Makoto KIKUCHI, Tokyo (JP); Tomohito KAMADA, Tokyo (JP); Chikashi NAGASHIMA, Saitama (JP)

(73) Assignee: Honda Motor Co., Ltd., Tokyo (JP)

(21) Appl. No.: 19/578,884

(22) Filed: Mar. 26, 2026

(30) Foreign Application Priority Data
Mar. 28, 2025 (CN) 202510384096.4

(51) Int. Cl. B62D 25/02; B62D 25/16; B60R 22/24

(52) U.S. Cl. CPC B62D 25/02; B62D 25/16; B60R 22/24

(57) ABSTRACT

The disclosure provides a vehicle body side structure, which has a lightweight structure. The vehicle body side structure includes: a rear column extending along a vehicle length direction above a rear wheel cover; and a mounting bracket having a retractor mounting portion. The rear column includes a first column and a second column located behind the first column. The mounting bracket has a connecting flange portion connected to the first column and the second column. The connecting flange portion is clamped between the first column and the second column to be connected.

### CROSS-REFERENCE TO RELATED APPLICATION

This application claims the priority benefit of China application serial no. 202510384096.4, filed on Mar. 28, 2025. The entirety of the above-mentioned patent application is hereby incorporated by reference herein and made a part of this specification.

### BACKGROUND

### Technical Field

The disclosure relates to a vehicle body side structure.

### Related Art

In recent years, in order to ensure access to more affordable, reliable, sustainable and advanced energy for more people, research and development related to lightweighting that contributes to energy efficiency is being performed.

In the prior art, Patent Document 1 provides a vehicle body structure. A bracket is mounted on a side rail disposed on a vehicle top plate side end and a rear rail disposed on a vehicle top plate rear end. A seat belt retractor is fixed on the bracket. The bracket of Patent Document 1 overlaps with the side rail from a car inner side, and is fixed with a bolt. However, since the bracket of Patent Document 1 is only fixed to the side rail through the bolt, and overlaps with the side rail from the inside of the vehicle, the bracket itself or a mounting portion of the bracket is prone to deformation due to a load from the seat belt retractor. The need for additional fixation may also lead to an increase in overall component weight. In this way, this may be disadvantageous for lightweighting the overall structure.

The disclosure aims to solve the foregoing problem to achieve lightweighting. Moreover, energy efficiency is also facilitated.

### Reference document of related art

### Patent document

[Patent document 1] Japanese patent publication no. 3716400.

### SUMMARY

The disclosure provides a vehicle body side structure, which has a lightweight structure.

According to an embodiment of the disclosure, a vehicle body side structure includes: a rear column, which extends along a vehicle length direction above a rear wheel cover; and a mounting bracket, which has a retractor mounting portion. The rear column includes a first column and a second column located behind the first column. The mounting bracket has a connecting flange portion connected to the first column and the second column. The connecting flange portion is clamped between the first column and the second column to be connected.

In one embodiment of the disclosure, the rear column further includes: an inner ridge line portion, which extends along the vehicle length direction; an outer ridge line portion, which extends along the vehicle length direction on a vehicle width direction outer side of the inner ridge line portion; a vehicle width surface portion, which is formed crossing from the inner ridge line portion to the outer ridge line portion; and a side surface portion, which extends along a vehicle height direction from at least one of the inner ridge line portion and the outer ridge line portion. The connecting flange portion includes a vehicle width surface connecting flange portion connected to the vehicle width surface portion and a side surface connecting flange portion connected to the side surface portion.

In one embodiment of the disclosure, the side surface portion includes: an inner side surface portion, which extends upward from the inner ridge line portion; and an outer side surface portion, which extends downward from the outer ridge line portion. The side surface connecting flange portion includes an inner side surface connecting flange portion connected to the inner side surface portion and an outer side surface connecting flange portion connected to the outer side surface portion.

In one embodiment of the disclosure, the vehicle width surface connecting flange portion, the inner side surface connecting flange portion, and the outer side surface connecting flange portion are continuously formed.

In one embodiment of the disclosure, the mounting bracket further includes a back connecting flange portion, and the back connecting flange portion extends backward from a rear end of the connecting flange portion and is connected to the second column.

In one embodiment of the disclosure, the back connecting flange portion includes a back inner side surface connecting flange portion, which extends backward from a rear end of an inner side surface connecting flange portion, and a back outer side surface connecting flange portion, which extends backward from a rear end of an outer side surface connecting flange portion. The mounting bracket has a bonding flange portion, which is connected to the back inner side surface connecting flange portion and the back outer side surface connecting flange portion.

In one embodiment of the disclosure, the mounting bracket has a mounting surface portion where the retractor mounting portion is formed. The connecting flange portion is formed in front of the mounting surface portion. The back connecting flange portion is formed to extend from the rear end of the connecting flange portion to a rear of the mounting surface portion.

In one embodiment of the disclosure, the vehicle body side structure has a closed section formed through the mounting bracket and the rear column. The closed section extends in the vehicle length direction along the rear column from the mounting surface portion.

In one embodiment of the disclosure, a pillar reinforcing component is provided on an outer side of the rear column in a vehicle width direction. When viewed from a side, the pillar reinforcing component overlaps with the connecting flange portion. The pillar reinforcing component relates to a range extending from a front of the connecting flange portion to a rear of the connecting flange portion.

In one embodiment of the disclosure, the vehicle body side structure further includes a retractor. The retractor is fastened to the retractor mounting portion of the mounting bracket with a bolt in the vehicle length direction, and fastened to the rear column with a bolt in a vehicle width direction.

Based on the above, in the embodiments of the disclosure, through the arrangement of the first column and the second column of the rear column, the vehicle body side structure configures the connecting flange portion of the mounting bracket to be clamped between the first column and the second column, which may more effectively prevent the connecting flange portion from falling off from the rear column. Thereby, the retractor may be firmly supported. Furthermore, in a condition where a structural thickness of the mounting bracket is thinned, the vehicle body side structure may also retain a needed structural strength, and decrease the need for a component for additional fixation, facilitating the lightweight of the vehicle body side structure.

To make the above features and advantages of the disclosure more obvious and understandable, embodiments are specifically provided below and described in detail with reference to the accompanying drawings as follows.

### BRIEF DESCRIPTION OF THE DRAWINGS

FIG. 1 is a schematic view of a vehicle body side structure according to an embodiment of the disclosure;

FIG. 2A is a schematic view of the vehicle body side structure in FIG. 1 from another viewing angle;

FIG. 2B is a schematic cross-sectional view of the vehicle body side structure in FIG. 2A along line B-B;

FIG. 3 is a schematic view of the mounting bracket of the vehicle body side structure in FIG. 1;

FIG. 4A is a partially enlarged schematic view of the vehicle body side structure in FIG. 1 near the mounting bracket when the retractor is not mounted;

FIG. 4B is a schematic cross-sectional view of the vehicle body side structure in FIG. 4A along line C-C;

FIG. 5 is a schematic view of the vehicle body side structure in FIG. 1 when viewed from an outer side;

FIG. 6 is a schematic cross-sectional view of the vehicle body side structure in FIGS. 1 and 5 along line A-A;

FIG. 7A is a partially enlarged schematic view of the vehicle body side structure in FIG. 1 near the retractor;

FIG. 7B is a schematic cross-sectional view of the vehicle body side structure in FIG. 7A along line D-D.

### DESCRIPTION OF THE EMBODIMENTS

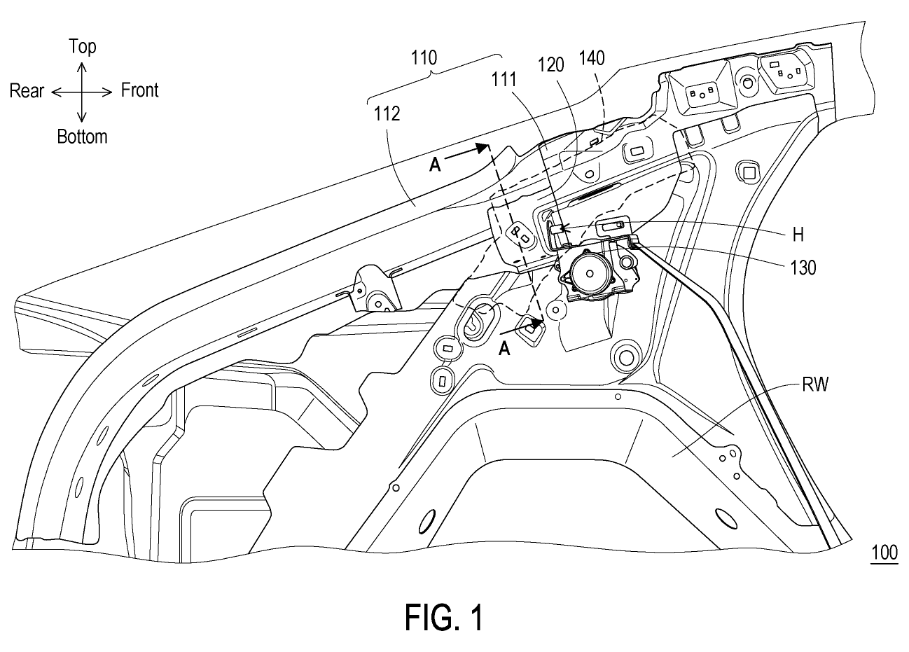

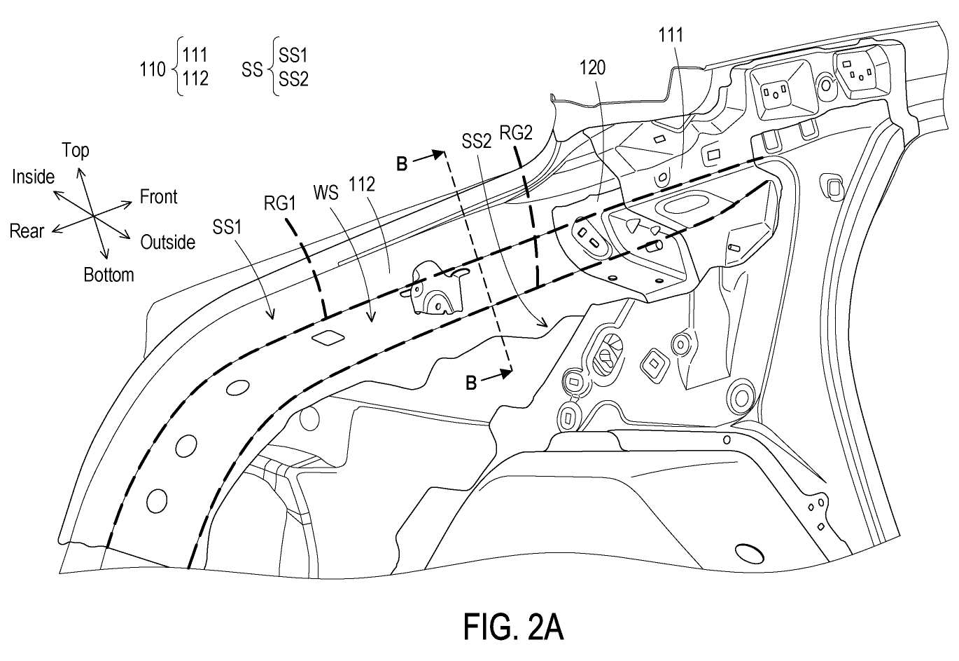

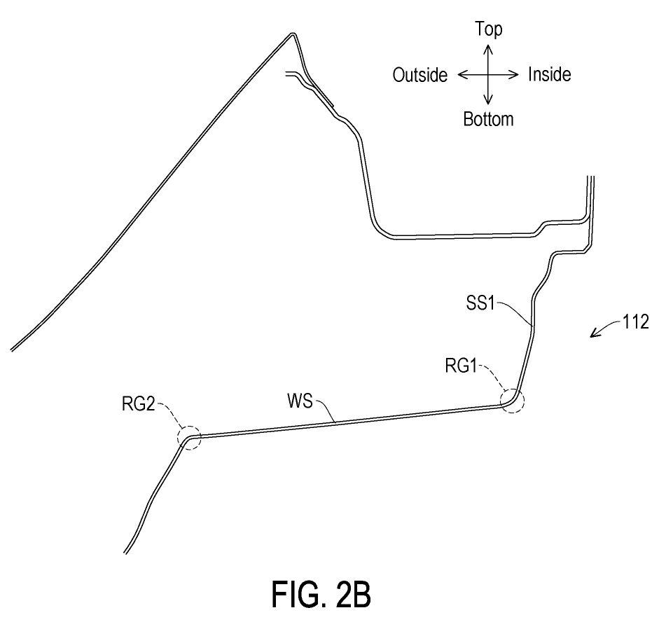

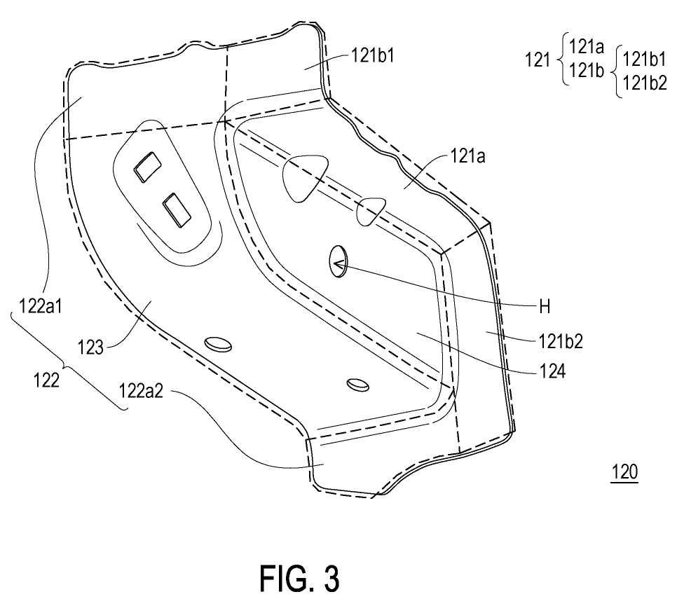

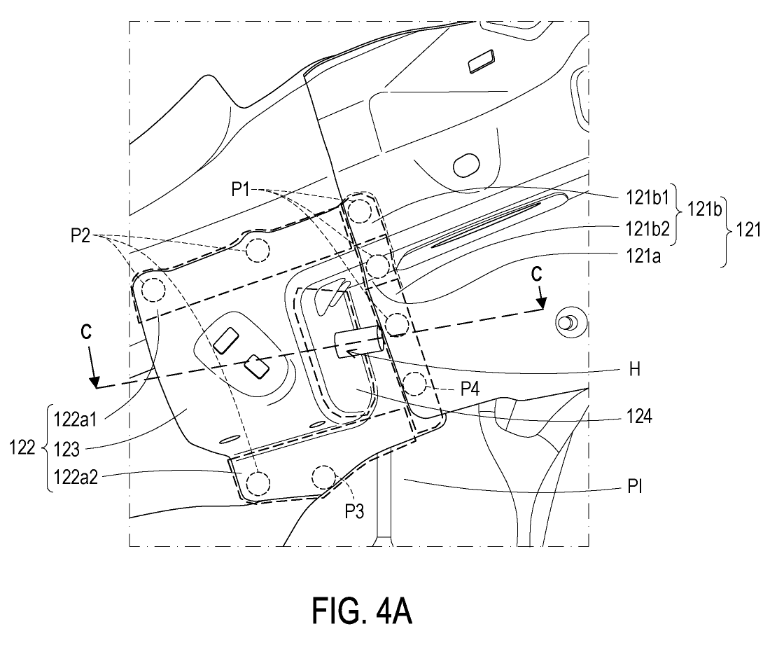

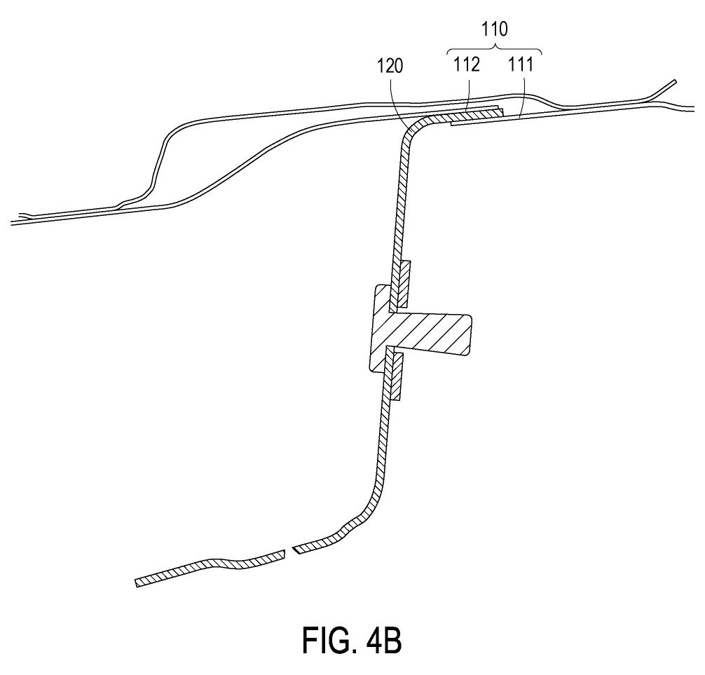

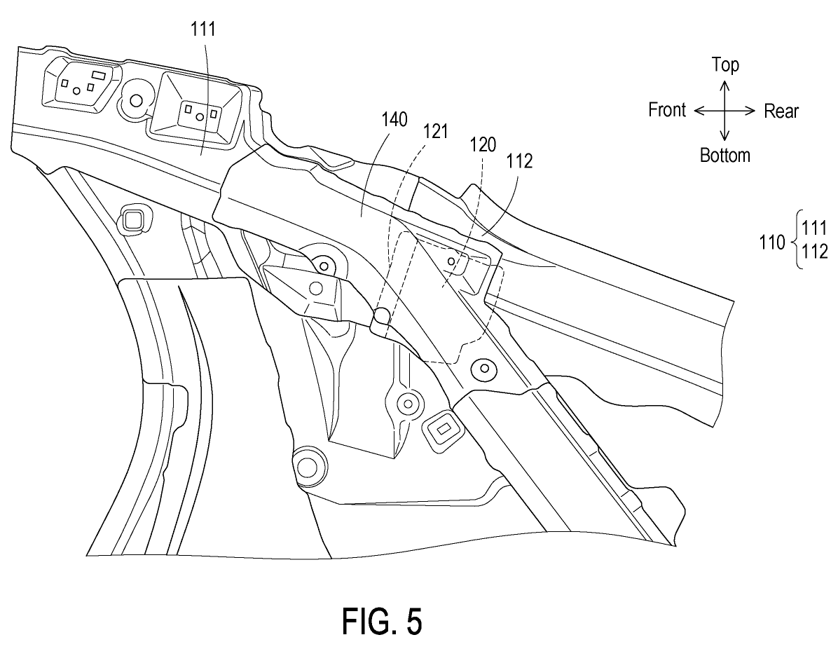

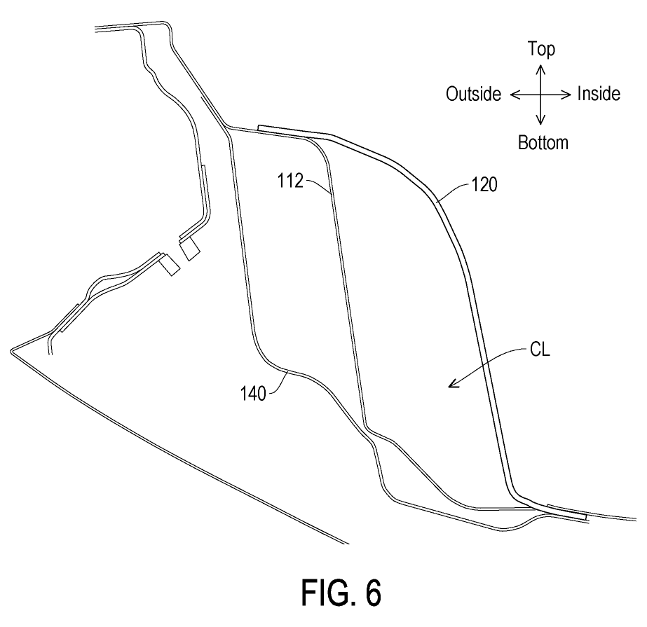

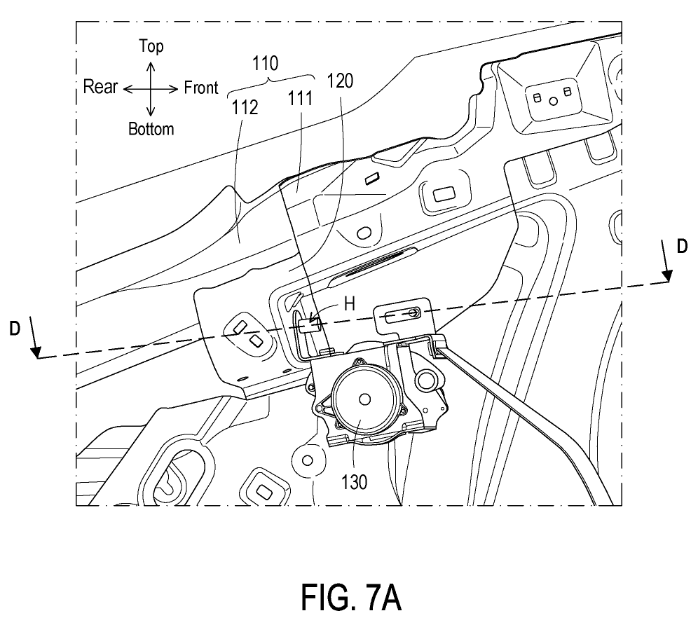

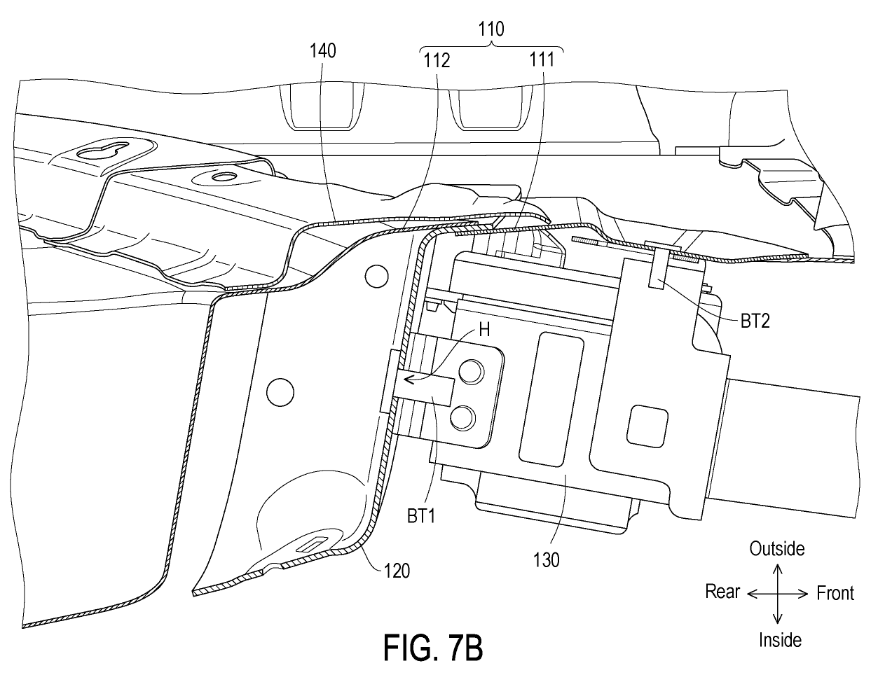

Hereinafter, reference will be made in detail to exemplary embodiments of the disclosure, and examples of the exemplary embodiments are illustrated in the figures. Wherever possible, the same reference numerals are used in the figures and the descriptions to refer to the same or similar portions. FIG. 1 is a schematic view of a vehicle body side structure according to an embodiment of the disclosure. FIG. 2A is a schematic view of the vehicle body side structure in FIG. 1 from another viewing angle. FIG. 2B is a schematic cross-sectional view of the vehicle body side structure in FIG. 2A along line B-B. FIG. 3 is a schematic view of the mounting bracket of the vehicle body side structure in FIG. 1. FIG. 4A is a partially enlarged schematic view of the vehicle body side structure in FIG. 1 near the mounting bracket when the retractor is not mounted. FIG. 4B is a schematic cross-sectional view of the vehicle body side structure in FIG. 4A along line C-C. FIG. 5 is a schematic view of the vehicle body side structure in FIG. 1 when viewed from an outer side. FIG. 6 is a schematic cross-sectional view of the vehicle body side structure in FIG. 1 and FIG. 5 along line A-A. FIG. 7A is a partially enlarged schematic view of the vehicle body side structure in FIG. 1 near the retractor. FIG. 7B is a schematic cross-sectional view of the vehicle body side structure in FIG. 7A along line D-D. In the embodiment, a vehicle body side structure 100 refers to a vehicle body structure located near rear columns on both sides of a vehicle. It should be noted that, for convenience, a front-rear direction, inside-outside direction, and top-bottom direction of the vehicle are defined as shown in the figures. The composition of each portion is described according to the definition. The front-rear direction, inside-outside direction, and top-bottom direction of the vehicle are respectively equivalent to a vehicle length direction, a vehicle width direction, and a vehicle height direction.

Please refer to FIGS. 1 and 2A. In the embodiment, the vehicle body side structure 100 includes a rear column 110, a mounting bracket 120, and a retractor 130. For example, the retractor 130 may be composed of components such as a webbing, a reel shaft, a U-shaped frame, a coil spring, a sensing component, and a locking component, and may be configured to retract and accommodate a seat belt that effectively protects a driver and a passenger in an emergency condition. Specifically, as shown in FIGS. 1 and 2A, the rear column 110 extends along the vehicle length direction above a rear wheel cover RW. The rear column 110 includes a first column 111 and a second column 112 located behind the first column 111. Furthermore, as shown in FIGS. 2A and 2B, in the embodiment, the rear column 110 further includes an inner ridge line portion RG1, an outer ridge line portion RG2, a vehicle width surface portion WS, and a side surface portion SS. The inner ridge line portion RG1 extends along the vehicle length direction. The outer ridge line portion RG2 extends along the vehicle length direction on a vehicle width direction outer side of the inner ridge line portion RG1. The vehicle width surface portion WS is formed crossing from the inner ridge line portion RG1 to the outer ridge line portion RG2. The side surface portion SS extends along the vehicle height direction from at least one of the inner ridge line portion RG1 and the outer ridge line portion RG2. As shown in FIG. 2B, in the embodiment, the side surface portion SS includes an inner side surface portion SS1 extending upward from the inner ridge line portion RG1 and an outer side surface portion SS2 extending downward from the outer ridge line portion RG2.

On the other hand, as shown in FIGS. 3 and 4A, the mounting bracket 120 has a retractor mounting portion H and a connecting flange portion 121. More specifically, as shown in FIG. 4B, the connecting flange portion 121 is connected to the first column 111 and the second column 112. The connecting flange portion 121 is clamped between the first column 111 and the second column 112 to be connected. For example, a connection manner between the connecting flange portion 121 and the first column 111 and the second column 112 is to perform spot welding at multiple solder joints P1 of the connecting flange portion 121 to connect the connecting flange portion 121, the first column 111, and the second column 112. In this way, in the embodiment, through the arrangement of the first column 111 and the second column 112 of the rear column 110, the vehicle body side structure 100 configures the connecting flange portion 121 of the mounting bracket 120 to be clamped between the first column 111 and the second column 112, which may more effectively prevent the connecting flange portion 121 of the mounting bracket 120 from falling off from the rear column 110. Thereby, the mounting bracket 120 may firmly support the retractor 130. Furthermore, in a condition where a structural thickness of the mounting bracket 120 is thinned, the vehicle body side structure 100 may also retain a needed structural strength and decrease the need for a component for additional fixation, allowing the vehicle body side structure 100 to be lightweight.

Furthermore, as shown in FIGS. 3 and 4A, in the embodiment, the connecting flange portion 121 of the mounting bracket 120 includes a vehicle width surface connecting flange portion 121a connected to the vehicle width surface portion WS and a side surface connecting flange portion 121b connected to the side surface portion SS. In this way, through the configuration of the connecting flange portion 121 being connected to the vehicle width surface portion WS and the side surface portion SS of the rear column 110, the mounting bracket 120 may be more firmly connected to the rear column 110. Furthermore, the side surface connecting flange portion 121b includes, for example, an inner side surface connecting flange portion 121b1 connected to the inner side surface portion SS1 and an outer side surface connecting flange portion 121b2 connected to the outer side surface portion SS2. In this way, the connecting flange portion 121 of the mounting bracket 120 may be connected to three surface portions of the rear column 110, which are the vehicle width surface portion WS, the inner side surface portion SS1, and the outer side surface portion SS2, allowing the mounting bracket 120 to be more firmly connected to the rear column 110. In addition, as shown in FIGS. 3 and 4A, the vehicle width surface connecting flange portion 121a, the inner side surface connecting flange portion 121b1, and the outer side surface connecting flange portion 121b2 are continuously formed. In this way, since the vehicle width surface connecting flange portion 121a, the inner side surface connecting flange portion 121b1, and the outer side surface connecting flange portion 121b2 are continuously formed without having a structure cut off a notch or the like, there is sufficient structural strength, thereby allowing the connection between the mounting bracket 120 and the rear column 110 to be firmer.

On the other hand, as shown in FIGS. 3 and 4A, in the embodiment, the mounting bracket 120 further includes a back connecting flange portion 122 and a bonding flange portion 123. The back connecting flange portion 122 extends backward from a rear end of the connecting flange portion 121 and is connected to the second column 112. Here, a connection manner between the back connecting flange portion 122 and the second column 112 is to perform spot welding at multiple solder joints P2 of the back connecting flange portion 122 to connect both the connecting flange portion 121 and the second column 112. In this way, the mounting bracket 120 may not only be connected to the first column 111 and the second column 112 of the rear column 110 through the connecting flange portion 121, but may also be connected to the second column 112 of the rear column 110 through the back connecting flange portion 122, thereby allowing the connection between the mounting bracket 120 and the rear column 110 to be firmer.

Furthermore, as shown in FIGS. 3 and 4A, in the embodiment, the back connecting flange portion 122 includes a back inner side surface connecting flange portion 122a1 extending backward from a rear end of the inner side surface connecting flange portion 121b1 and a back outer side surface connecting flange portion 122a2 extending backward from a rear end of the outer side surface connecting flange portion 121b2. The bonding flange portion 123 is connected to the back inner side surface connecting flange portion 122a1 and the back outer side surface connecting flange portion 122a2. In this way, through the configuration of the back inner side surface connecting flange portion 122a1 and the back outer side surface connecting flange portion 122a2 being connected through the bonding flange portion 123, there may be sufficient structural strength to effectively inhibit deformation of the mounting bracket 120 due to a load from the retractor 130. In addition, as shown in FIG. 4A, the back outer side surface connecting flange portion 122a2 of the mounting bracket 120 is clamped between a rear inner plate PI and the second column 112. Spot welding is performed at a solder joint P3 on the back outer side surface connecting flange portion 122a2 to connect the back outer side surface connecting flange portion 122a2, the rear inner plate PI, and the second column 112. In this way, the mounting bracket 120 may also be more firmly connected to the rear column 110.

In addition, as shown in FIGS. 3 and 4A, in the embodiment, the mounting bracket 120 has a mounting surface portion 124 where the retractor mounting portion H is formed. For example, the retractor mounting portion H is, for example, a mounting hole configured to fix the retractor 130 to the mounting bracket 120 with a bolt. Specifically, as shown in FIG. 4A, the connecting flange portion 121 is formed in front of the mounting surface portion 124. The back connecting flange portion 122 is formed to extend from the rear end of the connecting flange portion 121 to a rear of the mounting surface portion 124. The bonding flange portion 123 is connected the back inner side surface connecting flange portion 122a1 and the back outer side surface connecting flange portion 122a2 located behind the mounting surface portion 124. In this way, the mounting bracket 120 may extend from a front of the mounting surface portion 124 to the rear, and be connected to the second column 112 of the rear column 110, thereby firmly supporting the retractor 130.

In the embodiment, as shown in FIG. 5, the vehicle body side structure 100 is provided with a pillar reinforcing component 140 on an outer side of the rear column 110 in the vehicle width direction. When viewed from a side, the pillar reinforcing component 140 overlaps with the connecting flange portion 121. The pillar reinforcing component 140 relates to a range extending from a front of the connecting flange portion 121 to a rear of the connecting flange portion 121. In this way, the pillar reinforcing component 140 may reinforce the rear column 110 around the connecting flange portion 121, thereby inhibiting deformation of the rear column 110 due to a load of the retractor 130. Thereby, the retractor 130 may further be firmly supported.

On the other hand, as shown in FIG. 6, in the embodiment, the vehicle body side structure 100 forms a closed section CL through the mounting bracket 120 and the rear column 110. The closed section CL extends in the vehicle length direction along the rear column 110 from the mounting surface portion 124. In this way, through forming the closed section extending in the vehicle length direction along the rear column 110, a load from the retractor 130 may also be firmly supported.

In addition, as shown in FIGS. 7A and 7B, in the embodiment, the retractor 130 is fastened to the retractor mounting portion H of the mounting bracket 120 with a bolt BT1 in the vehicle length direction, and is fastened to the rear column 110 with a bolt BT2 in the vehicle width direction. In this way, through the configuration of the retractor 130 being fixed to the mounting bracket 120 with the bolt BT1 in the vehicle length direction and fixed to the rear column 110 with the bolt BT2 in the vehicle width direction, a load of the retractor 130 may be dispersed, thereby further decreasing the need for the pillar reinforcing component 140, facilitating the lightweight of the vehicle body side structure 100.

In summary, in the embodiments of the disclosure, through the arrangement of the first column and the second column of the rear column, the vehicle body side structure configures the connecting flange portion of the mounting bracket to be clamped between the first column and the second column, which may more effectively prevent the connecting flange portion from falling off from the rear column. Thereby, the retractor may be firmly supported. Furthermore, in a condition where a structural thickness of the mounting bracket is thinned, the vehicle body side structure may also retain a needed structural strength, and decrease the need for a component for additional fixation, allowing the vehicle body side structure to be lightweight.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A vehicle body side structure, comprising:
a rear column, extending along a vehicle length direction above a rear wheel cover; and
a mounting bracket, having a retractor mounting portion,
wherein the rear column comprises a first column and a second column located behind the first column, and
the mounting bracket has a connecting flange portion connected to the first column and the second column, and the connecting flange portion is clamped between the first column and the second column to be connected.

2. The vehicle body side structure according to claim 1, wherein the rear column further comprises:
an inner ridge line portion, extending along the vehicle length direction;
an outer ridge line portion, extending along the vehicle length direction on a vehicle width direction outer side of the inner ridge line portion;
a vehicle width surface portion, formed crossing from the inner ridge line portion to the outer ridge line portion; and
a side surface portion, extending along a vehicle height direction from at least one of the inner ridge line portion and the outer ridge line portion,
wherein the connecting flange portion comprises a vehicle width surface connecting flange portion connected to the vehicle width surface portion and a side surface connecting flange portion connected to the side surface portion.

3. The vehicle body side structure according to claim 2, wherein the side surface portion comprises:
an inner side surface portion extending upward from the inner ridge line portion; and
an outer side surface portion extending downward from the outer ridge line portion,
wherein the side surface connecting flange portion comprises an inner side surface connecting flange portion connected to the inner side surface portion and an outer side surface connecting flange portion connected to the outer side surface portion.

4. The vehicle body side structure according to claim 3, wherein the vehicle width surface connecting flange portion, the inner side surface connecting flange portion, and the outer side surface connecting flange portion are continuously formed.

5. The vehicle body side structure according to claim 1, wherein the mounting bracket further comprises a back connecting flange portion, and the back connecting flange portion extends backward from a rear end of the connecting flange portion and is connected to the second column.

6. The vehicle body side structure according to claim 5, wherein the back connecting flange portion comprises a back inner side surface connecting flange portion extending backward from a rear end of an inner side surface connecting flange portion and a back outer side surface connecting flange portion extending backward from a rear end of an outer side surface connecting flange portion, and
the mounting bracket has a bonding flange portion connected to the back inner side surface connecting flange portion and the back outer side surface connecting flange portion.

7. The vehicle body side structure according to claim 5, wherein the mounting bracket has a mounting surface portion where the retractor mounting portion is formed,
the connecting flange portion is formed in front of the mounting surface portion, and
the back connecting flange portion is formed to extend from the rear end of the connecting flange portion to a rear of the mounting surface portion.

8. The vehicle body side structure according to claim 1, wherein the vehicle body side structure has a closed section formed through the mounting bracket and the rear column, and the closed section extends in the vehicle length direction along the rear column from the mounting surface portion.

9. The vehicle body side structure according to claim 1, wherein a pillar reinforcing component is provided on an outer side of the rear column in a vehicle width direction,
when viewed from a side, the pillar reinforcing component overlaps with the connecting flange portion, and the pillar reinforcing component relates to a range extending from a front of the connecting flange portion to a rear of the connecting flange portion.

10. The vehicle body side structure according to claim 1, further comprising:
a retractor, wherein the retractor is fastened to the retractor mounting portion of the mounting bracket with a bolt in the vehicle length direction, and fastened to the rear column with a bolt in a vehicle width direction.

11. The vehicle body side structure according to claim 2, further comprising:
a retractor, wherein the retractor is fastened to the retractor mounting portion of the mounting bracket with a bolt in the vehicle length direction, and fastened to the rear column with a bolt in a vehicle width direction.

12. The vehicle body side structure according to claim 3, further comprising:
a retractor, wherein the retractor is fastened to the retractor mounting portion of the mounting bracket with a bolt in the vehicle length direction, and fastened to the rear column with a bolt in a vehicle width direction.

13. The vehicle body side structure according to claim 4, further comprising:
a retractor, wherein the retractor is fastened to the retractor mounting portion of the mounting bracket with a bolt in the vehicle length direction, and fastened to the rear column with a bolt in a vehicle width direction.

14. The vehicle body side structure according to claim 5, further comprising:
a retractor, wherein the retractor is fastened to the retractor mounting portion of the mounting bracket with a bolt in the vehicle length direction, and fastened to the rear column with a bolt in a vehicle width direction.

15. The vehicle body side structure according to claim 6, further comprising:
a retractor, wherein the retractor is fastened to the retractor mounting portion of the mounting bracket with a bolt in the vehicle length direction, and fastened to the rear column with a bolt in a vehicle width direction.

16. The vehicle body side structure according to claim 7, further comprising:
a retractor, wherein the retractor is fastened to the retractor mounting portion of the mounting bracket with a bolt in the vehicle length direction, and fastened to the rear column with a bolt in a vehicle width direction.

17. The vehicle body side structure according to claim 8, further comprising:
a retractor, wherein the retractor is fastened to the retractor mounting portion of the mounting bracket with a bolt in the vehicle length direction, and fastened to the rear column with a bolt in a vehicle width direction.

18. The vehicle body side structure according to claim 9, further comprising:
a retractor, wherein the retractor is fastened to the retractor mounting portion of the mounting bracket with a bolt in the vehicle length direction, and fastened to the rear column with a bolt in a vehicle width direction.
